(19) United States
(12) Patent Application Publication
(10) Pub. No.: US 2006/0227240 A1
(43) Pub. Date: Oct. 12, 2006

(54) Caption translation system and method using the same

(75) Inventors: Chaucer Chiu, Taipei (TW); Anthony Zhou, Shanghai (CN)

Correspondence Address: PEARL COHEN ZEDEK, LLP, 1500 BROADWAY 12TH FLOOR, NEW YORK, NY, 10036, US

(73) Assignee: INVENTEC CORPORATION

(21) Appl. No.: 11/092,868

(22) Filed: Mar. 30, 2005

(51) Int. Cl. H04N 9/12

(52) U.S. Cl. 348/383

(57) ABSTRACT

A caption translation system is applied in an electronic device equipped with a display unit. The system comprises a controlling module, an obtaining module, a translating module and an integrating module. First, the controlling module issues a command initiating the obtaining module to obtain a caption signal from the original video signal received by the electronic device; the translating module the translates the caption signal obtained by the obtaining module; last, the integrating module integrates the translation result generated by the translating module with the original video signal and delivers it to the display unit for outputting, so as to solve the language difficulties for the audience viewing a non-native language television program or a pre-recorded program such as on a VCD or DVD etc.

### FIELD OF THE INVENTION

The present invention relates to a video output technique, and more specifically, to a caption translation system that can translate a caption of an original video signal and output translated caption simultaneously with the original video, so as to let the user understand easily the meaning of the non-native language caption while watching the video program.

### BACKGROUND OF THE INVENTION

Due to development of video/audio multimedia industry (such as television programs, movies and music) as well as trend of globalization, people in different countries have more and more opportunities to get in touch with multimedia contents expressed in foreign languages. Meanwhile, as the number of people traveling abroad grows in each country, multimedia products introducing exotic cultures, beautiful scenic spots, foreign classic opera or drama might be bought back for personal viewing or as a collection.

In fact, manufacturers cannot possibly produce multimedia products with languages appropriate for the countries to which they are distributed under considerations of display effect, cost of production, transferring speed and amount of product releasing.

For this reason, multimedia products such as foreign television programs and movies in DVDs or VCDs played in local language would be difficult for audiences who are not familiar with the language to enjoy or even understand the contents played.

Therefore, there is a need to provide a technique for translating the output caption of multimedia products to a language suitable for the audience, so as to reduce additional translation fee and increase the sales and popularity of the foreign multimedia products.

### SUMMARY OF THE INVENTION

In light of the above drawbacks in the prior art, a primary objective of the present invention is to provide a caption translation system to perform a translation process on a caption for a video program outputted by a display unit of an electronic device, so as to allow an audience to understand the meaning of the video program by watching caption translated to a language familiar to the audience.

Another objective of the present invention is to provide a caption translation system, which can provide a sentence by sentence translation of the original caption outputted by the display unit or a real-time translation based on user-selected word/phrase.

Still another objective of the present invention is to provide a caption translation system, which can display the translation correspondingly below the original caption after the translation process, so that the user can view both the original and translated captions simultaneously.

In accordance with the foregoing and other objective, the present invention provides a caption translation system. The caption translation system in the present invention is applied in an electronic device equipped with a display unit, comprising (1) a controlling module sending a control signal to commence a translation of the original caption; (2) an obtaining module capturing a caption signal of an original video signal in the electronic device; (3) a translating module translating the caption signal received by the obtaining module; and (4) an integrating module integrating a translation result derived from the translation module with the original video signal and then delivering the integrated signal to the display unit for outputting. The caption translation system further comprises a pausing module activated according to the requirement of the user during the translation process so as to pause the playing of video signal outputted by the display unit, and a storing module for storing the subsequent original video signal received by the system after activation of the pausing module.

In addition, the caption translation method in the present invention equipped within an electronic device begins with selecting the desired translation language via the controlling module. Further, the obtaining module obtains the caption signal of the original video signal. If the translating module is not in a real-time word/phrase translation mode, then the translating module shall translate the caption obtained by the obtaining module in sentences. Then, the translation result is displayed below the original caption for easy comparison of both captions.

On the contrary, if the translating module is set to the real-time word/phrase translation mode, the pausing module is activated to pause the video program being played, and the storing module stores the original video signal inputted after the pausing module is activated; next, the desired words for translation can be selected via the controlling module and translated by the translating module. Finally, the translated caption is outputted below the original caption shown on the display unit.

Comparing to the prior art, the caption translation system can translate the caption of a video program played in an electronic device in a sentence-based or real-time word-/phrase-based translation manner. Thus, a user who is watching a non-native language film can benefit greatly from the real-time translation of the caption.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing the basic structure of the caption translation system in the present invention;

FIG. 2 is a flow chart showing procedural steps of a caption translation method performed by the caption translation system in accordance with the present invention;

FIGS. 3A & 3B are examples of caption translations shown in a display unit according to the present invention.

### DETAILED DESCRIPTION OF THE PREFERRED EMBODIMENTS

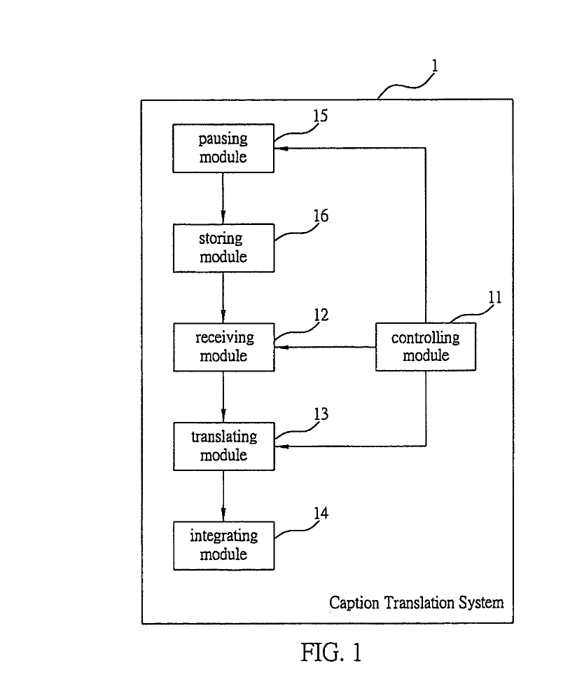

Preferred embodiments of a caption translation system proposed in the present invention are described in detail as follows with reference to FIG. 1 to FIG. 3B.

The following is intended to provide a detailed description of an example of the invention and should not be taken to be limiting of the invention itself. Rather, any number of variations may fall within the scope of the present invention which is defined in the claims following the description.

FIG. 1 is a block diagram showing the basic structure of the caption translation system 1 in the present invention. As shown in FIG. 1, the caption translation system 1 comprises a controlling module 11, an obtaining module 12, a translating module 13, an integrating module 14, a pausing module 15 and a storing module 16.

The controlling module 11 can be used to send a control signal, so as to let the caption translation system 1 enter into a preparation status before commencing a translation process. In this preferred embodiment, the controlling module 11 is a remote controller comprising a translation key, a translation language selection key, a phrase selection key and a plurality of direction keys including up/down and right/left keys.

The obtaining module 12 is used to obtain caption signal of an original video signal received by an electronic device. The system 1 is capable of translating languages such as Chinese to English, English to Chinese, Japanese to Chinese, Chinese to Japanese, English to German and German to English and likewise (actual application is not limited to these languages but can be expanded to other languages according to user's need). The original video signal comprises a caption signal and an image signal, wherein the caption signal is transmitted in two ways. One way is that the caption signal is transmitted as an independent signal stream along with the television signal, and the obtaining module 12 would obtain such caption signal by analyzing the original video signal; the second way is that the caption signal is mixed with the image signal and transmitted as part of the whole image, and the obtaining module 12 would obtain such caption signal by separating the image and text signals and identifying the text signals.

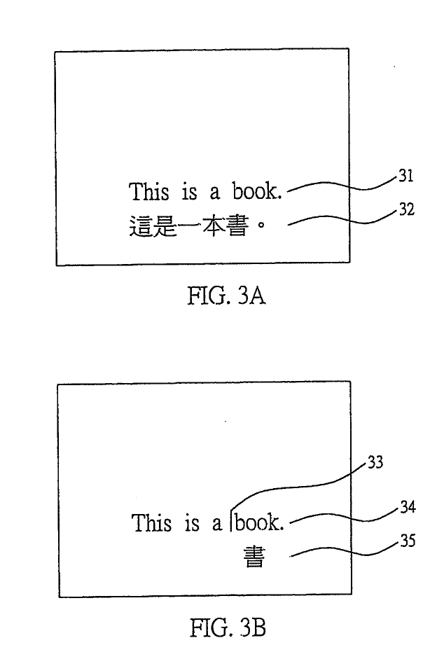

The translating module 13 is used to translate the caption signal obtained by the obtaining module 12. The translation module 13 translates the caption in a sentence-based or a real-time word-based (a word or a vocabulary) via a translating engine (not shown). Since the technique of translating words and sentences by integrating software and hardware is well known in the art, therefore it is not to be further described herein. In this preferred embodiment, the controlling module 11 provides a highlighted cursor 33 at the original caption position shown on the monitor of a display unit (not shown), so as to allow the user to select the desired word to be translated in a real-time manner via the direction keys. When the highlighted cursor 33 stays at a certain word for a period of time, the real-time word translating function is activated and the corresponding translated word will be generated, outputted and displayed below the selected word by the translating engine. If the highlighted cursor 33 is moved, the translated word will disappear. As shown in FIG. 3A, the original caption outputs a sentence of “This is a book.” as a complete English sentence 31 during the process of translating English to Chinese. If the foregoing sentence is to be translated in a whole sentence manner, a Chinese sentence 32, [symbol] will be displayed below the foregoing sentence. As shown in FIG. 3B, if the user wishes to see translation of an English word 34 “book”, the user may move the highlighted cursor 33 to the word 34 “book” using the direction keys of the controlling module to select the word, and after the cursor remains there for a short period of time, the corresponding Chinese translation 35 [symbol] for the English word “book” will be displayed below it until the highlighted cursor 33 is moved to another word.

In a language, often a plurality of characters may form a single unit having a meaning (this single unit made of a plurality of characters or words will be referred to as a “phrase” throughout this specification), such as the Chinese characters in Chinese language. Thus, the user can choose to translate a group of characters forming a phrase instead of a single character. For instance, if the user wishes to translate two Chinese characters [symbol] (together they correspond to the English word “weather”) in a sentence of an original caption into English, then the user needs to move the highlighted cursor 33 to the first character [symbol] while pressing the phrase selection key of the controlling module 11, then highlights the other character [symbol] then the English translation “weather” will appear underneath the group of characters [symbol] after a short period of time. The English translation will disappear when the highlighted cursor 33 moves again.

The integrating module 14 is employed to integrate the translation result generated by the translating module 12 with the original video signal, so that it can be sent to the display unit for outputting.

A pausing module 15, which is activated at the commencement of the real-time word selection translation, is employed to pause the playing of the original video signal outputted by the display unit.

A storing module 16 is used to store subsequent original video signal received by the system 1 when the pausing module 15 is activated, so as to avoid loss of the subsequent original video signal.

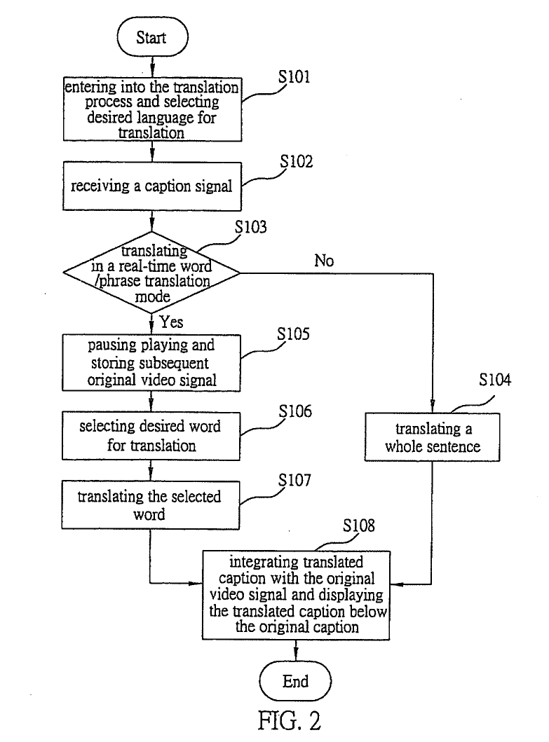

FIG. 2 is a flow chart showing procedural steps of a caption translation method performed by the caption translation system 1 in accordance with the present invention.

As shown in FIG. 2, in step S101, the user can make the caption translation system 1 enter into a preparation status for translation process by pressing the translation key on the controlling module 11, allowing the user to select the desired translating language. Then, step S102 is entered.

In step S102, the obtaining module 12 obtains a caption signal, and step S103 is entered.

In step 103, the desired translation type is chosen by the user via the controlling module 11. If the real-time word-based translation is selected, then step S105 is directly entered; if the sentence-based translation is selected, step S104 is entered.

In step 104, the translating module 13 performs the sentence-based translation of the caption signal received by the obtaining module 12. Then, step S108 is entered.

In step S105, the pausing module 15 is activated to pause the playing of the video signal outputted by a display unit. Then, the storing module 16 stores the original video signal received by the electronic device after the activation of the pausing module 15, so that it can be played later. Then, step S106 is performed.

In step S106, the desired word or phrase for real-time translated is selected by the user via the controlling module 11. Then, step 107 is entered.

In step S107, the translating module 13 translates the desired word selected by the user. Then, step 108 is performed.

In step S108, the integrating module 14 integrates the translation result generated by the translating module 13 with the original video signal and displays the translation result below the original caption.

As described above, the caption translation system in the present invention is employed to translate the caption outputted by the display unit in a sentence-based manner or a real-time word-/phrase-based manner. Thus, a user who is watching a non-native language film can benefit greatly from the real-time translation of the caption.

The invention has been described using exemplary preferred embodiments. However, it is to be understood that the scope of the invention is not limited to the disclosed embodiments. On the contrary, it is intended to cover various modifications and similar arrangement. The scope of the claims therefore should be accorded the broadest interpretation so as to encompass all such modifications and similar arrangements.

What is claimed is:

1. A caption translation system applicable to an electronic device equipped with a display unit, the system comprising:
a controlling module for sending a control signal inputted by a user to make the system enter into a preparation status for translation;
an obtaining module for obtaining a caption signal from an original video signal received by the electronic device while the system entering into the preparation status;
a translating module for translating the caption signal received by the obtaining module and generating a translation signal; and
an integrating module for integrating the translation signal derived from the translating module with the original video signal and delivering the integrated signal to the display unit for outputting.

2. The caption translation system of claim 1, wherein the original video signal comprises a caption signal and an image signal.

3. The caption translation system of claim 2, wherein the caption signal can be an independent signal separated from the image signal or mixed with the image signal as a portion of the whole image.

4. The caption translation system of claim 1, wherein the obtaining module identifies the image and the text respectively in the original video signal, so as to get the caption signal.

5. The caption translation system of claim 1, wherein the controlling module comprises at least one selected from the group consisting of a translating key, a translation language selection key, a phrase selection key and a plurality of direction keys.

6. The caption translation system of claim 1, wherein the system further comprises a pausing module for pausing the video being played.

7. The caption translation system of claim 1, wherein the system further comprises a storing module for storing the original video signal received subsequently by the electronic device.

8. The caption translation system of claim 1, wherein the electronic device is a television comprising a LCD (liquid crystal display) monitor.

9. The caption translation system of claim 1, wherein the translation signal is outputted by the display unit and displayed correspondingly below the original caption.

10. A caption translation method applicable to an electronic device equipped with a display unit for translating caption of a video played by the electronic device via a caption translation system, the method comprising the following steps of:
(1) entering the caption translation system into a preparation status for translation and selecting the translation language by a user;
(2) obtaining a caption signal from the video signal;
(3) translating the caption signal into language selected by the user;
(4) integrating the translated signal to the video signal; and
(5) displaying the translated caption correspondingly with an original caption shown on the display unit.

11. The caption translation method of claim 10, wherein the step (3) of translating the caption signal further comprises the following steps of:
(3-1) determining whether the user chooses a real-time word translation mode or a sentence translation mode; if a real-time word translation mode is chosen, then step (3-2) is entered; else if a sentence translation mode is chosen, step (3-5) is entered;
(3-2) pausing the video being played and storing the video signal for subsequent playing, then, step (3-3) is performed;
(3-3) allowing the user to choose at least a word in the caption for translation, then step (3-4) is performed;
(3-4) translating the at least one selected word into the language selected by the user, then step (4) is performed; and
(3-5) translating the whole sentence into the language selected by the user, then step (4) is performed.

12. The caption translation method of claim 11, wherein the user selects the at least one word for translation by moving a highlighted cursor to the word in the original caption shown on the display unit during the real-time translation mode.

13. The caption translation method of claim 12, wherein in the real-time translation mode, the translated word/phrase is displayed until the cursor is moved to another word.

14. The caption translation method of claim 10, wherein the step (5) of displaying the translated caption correspondingly with an original caption shown on the display unit displays the translated caption corresponding underneath the original caption.
